(19) United States
(12) Patent Application Publication
(10) Pub. No.: US 2011/0180972 A1
(43) Pub. Date: Jul. 28, 2011

(54) METHOD FOR MANUFACTURING UNIFORMLY SEPARATED NANOFILAMENTS OR MICROFIBERS

(75) Inventors: Jae Rock Lee, Daejeon (KR); Seung Hwan Lee, Seoul (KR)

(73) Assignee: Korea Research Institute of Chemical Technology, Daejeon (KR)

(21) Appl. No.: 12/853,932

(22) Filed: Aug. 10, 2010

(30) Foreign Application Priority Data
Jan. 25, 2010 (KR) 10-2010-0006470

(51) Int. Cl. B29C 47/00; D01D 5/00; B82Y 40/00

(52) U.S. Cl. 264/465; 977/900

(57) ABSTRACT

Method for manufacturing uniformly separated, nanofibers, nanofilaments or microfibers. In some embodiments, the method includes steps of preparing a spinning or molten solution with a electrospinning raw material, electrospinning the solution to manufacture nanofibers, collecting the nanofibers, stretching the nanofibers, and heat-treating the collected nanofibers for a prescribed period of time. Nanofibers having a diameter of 1000 nm or less and microfibers having a diameter of 1 to 5 μm can be manufactured by methods of the invention.

### CROSS-REFERENCES TO RELATED APPLICATION

This patent application claims the benefit of priority from Korean Patent Application No. 10-2010-0006470, filed on Feb. 1, 2010, the contents of which are incorporated herein by reference.

### BACKGROUND OF THE INVENTION

1. Field of the Invention

The present invention relates to a method for manufacturing uniformly separated nanofilaments or microfibers.

2. Description of the Related Art

In general, nanofibers are ultrafine fibers having a fiber diameter level of 1 to 1,000 nm. The nanofibers are capable of providing various physical and chemical properties that cannot be obtained in conventional micron-sized fibers. Webs comprising the nanofibers are porous membrane type materials and can be used very usefully in diverse fields such as varieties of filters, wound dressings, scaffolds, biomedical clothes, second battery separator membranes, nanocomposites, and others. If trends of technologies on electrospinning up to now are reviewed, most technology trends are contents on manufacturing of nanofiber webs or nanofiber mats. It can be seen that technical core contents on the technologies represent much to methods of manufacturing nanowebs, nanomats or nanofilaments using high pressure compressed air or a vacuum device such as a vacuum pump, and imparting various anisotropic properties or functionalities to the nanowebs, nanomats or nanofilaments. Further, it has also been reported that thin and long nanofibers of continuous phase are successfully when manufacturing the nanowebs or nanomats using a water bath or polarization changes. However, there have been many limits in physical or chemical utilizability of the conventional nanofibers when conventional nanofibers are applied to present diverse industries since the conventional nanofibers are very thin, and there is a problem that it is hard to perform a separate post-processing process after spinning. Therefore, it is necessary to improve elongation properties or molecular orientation in the fiber axial direction or to further stabilize internal structures of the fibers through diverse post-processing processes including stretching, thermal treatment, oxidation, carbonization and others in order to improve physical properties of electrospun fibers and apply the electrospun fibers to commercial uses. However, a real limiting condition is that it is generally quite hard to heat-treat electrospun products in a nanoweb or nanomat phase for a sufficient time by a present technology when the electrospun products are in a state of tension.

Typical is an electrospinning method of manufacturing nanofibers having fine diameters by spinning a dope in the electrically charged state as described above as a well-known method of manufacturing nanofibers. For instance, methods of manufacturing nanofibers using the electrospinning method have been suggested in various patents and documents, and a plurality of the methods of manufacturing nanofibers have been typically disclosed in Korean Patent Laid-Open Publication Nos. 2007-0742421, 2007-0699315 and 2006-0630578, U.S. Pat. No. 6,183,670, and others. However, most nanofibers manufactured by the foregoing electrospinning method are limited to the form of a web or mat phase. Doshi et al. are giving an explanation for the reason that the nanofibers are formed in the form of nanowebs, that is, nonwoven fabrics since the nanofibers formed on the collector are collected not in an isotropic orientation, but in an anisotropic orientation, in a process that a polymer solution is collected on a collector and nanofibers are generally formed as droplets formed on the tip of a spinning nozzle are being broken during the application of a high voltage in the conventional electrospinning method. Further, the nanofibers in the form of nonwoven fabrics have a problem that the single fibers are collected with one another and interfered or bonded with one another to be agglomerated with one another before the droplets reach the collector in a process that droplets formed on the tip of the spinning nozzle are being spun toward the collector under a critical voltage during electrospinning since such nanofibers in the form of nonwoven fabrics are comprised of single fibers. Although it is disclosed in Korean Patent Laid-Open Publication No. 2002-50381 that nanofibers are manufactured by an conventional electrospinning method using a polyethylene terephthalate and polyester copolymer which is not a single component as a spinning solution, the foregoing manufactured nanofibers also are not deviated from the form of webs. The above-mentioned nanofibers of the form of webs have very weak mechanical strength, separate connecting fibers for connecting single fibers during manufacturing of yarns are required in the nanofibers of the form of webs when manufacturing yarns by twisting particularly nanofibers of the form of nonwoven fabrics, and the nanofibers of the form of webs cause finally manufactured yarns to be easily disconnected. Accordingly, it is urgently required to improve the process in order to apply the nanofibers of the form of webs to various required fields.

Therefore, inventors of the present invention have completed this invention after developing a method of manufacturing nanofilaments or microfibers while striving to obtain nanofibers capable of filling more diverse fields, wherein the ultrafine fibers are manufactured by apparatus and method of manufacturing the nanofilaments, and the method of manufacturing the nanofilaments comprises primarily collecting nanofibers spun in a dry or wet process using the electrospinning method and secondly collecting the primarily-collected nanofibers by a winding roller to manufacture uniform-sized nanofibers, and performing stretching and heat treatment processes of the nanofibers to manufacture nanofilaments which can be uniformly separated between nanofibers, and which have nano-sized diameters and improved mechanical properties.

### SUMMARY OF THE INVENTION

One object of the present invention is to provide a method for manufacturing uniformly separated nanofilaments or microfibers.

In order to achieve the object, an embodiment of the present invention provides a method for manufacturing uniformly separated nanofilaments or microfibers, the method comprising: a first step of dissolving electrospinning raw material into an organic solvent to prepare a spinning solution or melting the electrospinning raw material to prepare a molten solution; a second step of primarily collecting the nanofibers in a dry or wet process and secondly collecting the primarily-collected nanofibers by a winding roller after electrospinning the spinning solution or molten solution prepared in the first step at a critical voltage of 10 to 30 kV to manufacture nanofibers; and a third step of heat-treating the stretched nanofibers at least glass transition temperature of the electrospinning raw material for a predetermined time after stretching the nanofibers manufactured in the second step and holding the stretched nanofibers at a boiling temperature of the organic solvent or less and an atmospheric pressure or reduced pressure condition for a predetermined time.

In an embodiment of a method for manufacturing uniformly separated nanofilaments or microfibers according to the present invention, nanofibers having a diameter of 1000 nm or less and microfibers having a diameter of 1 to 5 μm can be manufactured in a continuous phase by adding additives in a spinning solution or molten solution or electrospinning the spinning solution or molten solution and collecting the electrospun spinning solution or molten solution in a wet process and containing the collected electrospun solution in a water bath, thereby completely separating the electrospun solution into individual fibers in the stretching step and the multiple heating and heat treatment steps. Therefore, the method for manufacturing uniformly separated nanofilaments or microfibers is capable of being usefully used in manufacturing fields of nanofibers such as varieties of filters, wound dressings, scaffolds, biomedical clothes, second battery separator membranes and nanocomposites, and in manufacturing fields of functional microfibers for improving conventional products.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a mimetic diagram of an apparatus used in a dry type electrospinning process in the manufacturing method of the present invention;

FIG. 2 is a mimetic diagram of an apparatus used in a wet type electrospinning process in the manufacturing method of the present invention;

FIG. 3 is a graph showing the viscosity of a polyamideimide spinning solution that is an electrospinning raw material used in the present invention;

FIG. 4(a) and FIG. 4(b) are scanning electron microscopic images of nanofibers according to stretching and heat treatment processes in a state that additives are not used;

FIG. 5(a) is a scanning electron microscopic image of nanofilaments manufactured by the manufacturing method according to an embodiment of the present invention; and

FIG. 5(b) is a scanning electron microscopic image of nanofibers manufactured without performing a stretching or heat treatment process; and

FIG. 6 is a graph showing tensile strength of nanofilaments manufactured by the manufacturing method according to the an embodiment of present invention.

### DESCRIPTION OF THE PREFERRED EMBODIMENTS

Features and advantages of the present invention will be more clearly understood by the following detailed description of the present preferred embodiments by reference to the accompanying drawings. It is first noted that terms or words used herein should be construed as meanings or concepts corresponding with the technical sprit of the present invention, based on the principle that the inventor can appropriately define the concepts of the terms to best describe his own invention. Also, it should be understood that detailed descriptions of well-known functions and structures related to the present invention will be omitted so as not to unnecessarily obscure the important point of the present invention.

The present invention provides a method for manufacturing uniformly separated nanofilaments, comprising: a first step of dissolving electrospinning raw material into an organic solvent to prepare a spinning solution or melting the electrospinning raw material to prepare a molten solution; a second step of primarily collecting the nanofibers in a dry or wet process and secondly collecting the primarily-collected nanofibers by a winding roller after electrospinning the spinning solution or molten solution prepared in the first step at a critical voltage of 10 to 30 kV to manufacture nanofibers; and a third step of heat-treating the stretched nanofibers at least glass transition temperature of the electrospinning raw material for a predetermined time after stretching the nanofibers manufactured in the second step and holding the stretched nanofibers at a boiling temperature of the organic solvent or less and an atmospheric pressure or reduced pressure condition for a predetermined time.

Hereinafter, a method for manufacturing uniformly separated nanofilaments according to the present invention will be described step by step in detail.

In a method for manufacturing nanofilaments according to the present invention, the first step is a step of preparing a spinning solution or molten solution used in electrospinning.

The spinning solution of the first step can be prepared by dissolving electrospinning raw material into an organic solvent, and the molten solution can be prepared by melting the electrospinning raw material.

The electrospinning raw material of the first step may include polyimide, polyamideimide, polyurethane, polyacrylonitrile, and polycaprolactam. The organic solvent of the first step is selected from the group consisting of DMF (dimethylformaldehyde), DMAc (dimethylacetamide), DMSO (dimethyl sulfoxide), NMP (N-methyl-2-pyrrolidone), or a combination of two or more thereof.

Further, it is preferable that the electrospinning raw material is contained in the spinning solution in the amount of 2 to 65% by weight with respect to the organic solvent since it is preferable to maintain a proper concentration level of the spinning solution or molten solution in the first step such that surface tension or molecular weight is capable of being controlled. There are problems that the electrospinning raw material is not manufactured into nanofibers and beads are formed on the fibers since molecular weight of the spinning solution is lowered if the electrospinning raw material is contained in the spinning solution in the amount of less than 2% by weight with respect to the organic solvent. There are problems that electrospinning is not capable of being performed and nano-sized fibers are not capable of being manufactured due to entanglement of polymer chains if the electrospinning raw material is contained in the spinning solution in the amount of exceeding 65% by weight with respect to the organic solvent.

Furthermore, the spinning solution or molten solution of the first step may further comprise 0.01 to 30% by weight of an additive, and the additive may include glycerol, polyethylene glycol, mineral oil, acetic acid, and citric acid.

Spinning of the spinning solution or molten solution is greatly improved in the electrospinning process, and thicknesses of the nanofibers become uniform through the additive. The spinning solution or molten solution is capable of being separated into respective nanofibers through subsequent stretching and multistep heat-increasing heat treatment processes. There is a problem that the nanofilaments are not uniformly separated since the nanofilaments are not smoothly separated if the additive is contained in the spinning solution or molten solution in the amount of less than 0.01% by weight. There are problems that the manufactured nanofibers are not smoothly wound, physical properties of the wound nanofibers are deteriorated, and the wound nanofibers are easily subject to embrittlement since viscosity of the spinning solution increases if the additive is contained in the spinning solution or molten solution in the amount of exceeding 30% by weight.

Furthermore, the method for manufacturing nanofilaments according to the present invention may further comprise a step of additionally heat-treating the spinning solution in a temperature range of 60 to 3500° C. after performing the first step. Since a hydrolysis reaction is not occurred by the heat treatment process, the spinning solution or molten solution is smoothly spun in the electrospinning process such that uniform-sized nanofibers can be manufactured. Particularly, in case of polyamideimide of the following chemical formula 1, it is preferable to use polyamideimide having its hardening (imidization) reaction performed as much as 10 to 50%. There is a problem that formability of the nanofibers deteriorates since the nanofibers are reacted with water presenting in the air to generate a hydrolysis reaction if the hardening reaction is performed as much as less than 10%. There is a problem that the electrospinning process is not capable of being performed since solubility with respect to the organic solvent deteriorates if the curing reaction is performed as much as more than 50%.

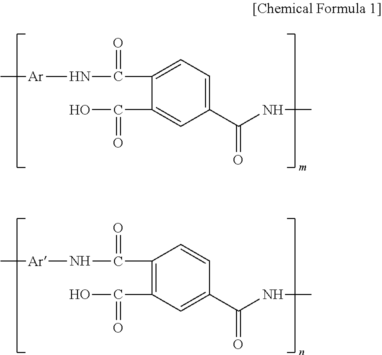

Where, m+n=1500˜10000.

Next, the second step in a method for manufacturing nanofilaments according to the present invention is a step of manufacturing the nanofibers by performing electrospinning.

In the foregoing second step, the nanofibers can be manufactured by primarily collecting the nanofibers in a dry or wet process and secondly collecting the primarily-collected nanofibers by a winding roller after electrospinning the spinning solution or molten solution prepared in the first step at a critical voltage of 10 to 30 kV to manufacture nanofibers. There is a problem that the fibers are manufactured not into nanofibers, but into microfibers since thicknesses of fibers increase if the critical voltage is less than 10 kV and the spinning solution has a high concentration. If the critical voltage is more than 30 kV, there are problems that stability of a matrix phase deteriorates, it is difficult to secure safety of an operator, and an excessive amount of energy is consumed in the energy efficiency aspect.

If the nanofibers are primarily collected by a dry process in the second step, the dry type collection process of the second step is carried out by a flat type collector, a roller type collector, or a multi-collector which is a mixed form of the flat type collector and roller type collector.

Further, the water bath of the second step may further comprise an additive such as glycerol, polyethylene glycol, mineral oil, acetic acid, citric acid, or the like. The nanofibers are capable of being uniformly separated through subsequent stretching and multistep heat-increasing heat treatment processes by comprising the additive such that surfaces of the nanofibers are coated with the additive. Furthermore, the nanofibers manufactured in the second step are preferably coated with the additive to a thickness of 10 to 30 μm. There is a problem that the nanofibers are not effectively or uniformly separated since the additive is not sufficiently coated on the surfaces of the nanofibers if the coating thickness is less than 10 μm. There is a problem that the nanofibers are fused in the stretching and heat treatment processes if the coating thickness is more than 30 μm.

Next, the third step in a method for manufacturing nanofilaments according to the present invention is a step of heat-treating the stretched nanofibers at least glass transition temperature of the electrospinning raw material for a predetermined time after stretching the nanofibers manufactured in the second step and holding the stretched nanofibers at a boiling temperature of the organic solvent or less and an atmospheric pressure or reduced pressure condition for a predetermined time.

It is preferable that the heat treatment process comprises heat-treating the stretched nanofibers at least glass transition temperature of the used electrospinning raw material for 10 to 360 minutes after holding the stretched nanofibers at a boiling temperature of the used solvent or less and an atmospheric pressure or reduced pressure condition for 5 to 360 minutes. In order to more effectively accomplish uniform separation of the nanofibers into individual fibers, it is more preferable that the heat treatment process may further comprise increasing temperature of the stretched nanofibers to a final heat treatment temperature over multiple steps of 1 to 10 steps between the holding temperature of the boiling temperature or less of the organic solvent and the heat treatment temperature of the at least glass transition temperature of the electrospinning raw material.

For instance, if N-methyl-2-pyrrolidone (NMP) as an organic solvent and polyamideimide as electrospinning raw material according to the present invention are used, the heat treatment process of the third step can be performed for 10 to 180 minutes by increasing temperature of the stretched nanofibers to 330° C. after holding the stretched nanofibers at 202° C., a boiling temperature of NMP or less, and an atmospheric pressure or reduced pressure condition for 5 to 180 minutes. A heat-increasing heat treatment process of multiple steps of 1 to 10 steps may be further performed between the foregoing temperatures.

The nanofibers manufactured in the second step are stretched and heat-treated such that organic solvent, additive and others in the nanofibers are removed through free volume. The organic solvent, additive and others in the nanofibers are removed together with external coating materials when stretching the nanofibers. Further, physical properties of the fibers are capable of being improved by uniformly separating nanofibers formed in bundles, allowing molecules in the fibers to have high orientation properties in the fiber axial direction, and increasing crystallinity of the fibers through the stretching and heat treatment processes of the third step. However, there is a problem that the nanofibers are fused with one another when nanofibers manufactured by electrospinning are heat-treated in a rapid temperature range.

Furthermore, the present invention provides a method for manufacturing microfibers having a diameter range of 1 to 5 μm by using the foregoing manufacturing method.

The nanofilaments may be manufactured by increasing the concentration of the spinning solution or molten solution in the electrospinning process to 1.2 to 3.5 times the concentration in the manufacturing process of the nanofilaments, by increasing the concentration of the spinning solution or molten solution in the electrospinning process to 1.2 to 3.5 times the concentration of a spinning solution or molten solution used in the manufacturing process of the nanofilaments, or by applying a voltage of 1 to 10 kV which is a lower level than that of the nanofilaments to a relative humidity of 100% or amine vapor during electrospinning such that microfibers having a diameter range of 1 to 5 μm are manufactured in a method for manufacturing nanofilaments according to the present invention.

Therefore, in a method for manufacturing uniformly separated nanofilaments or microfibers according to the present invention, nanofibers having a diameter of 1000 nm or less and microfibers having a diameter of 1 to 5 μm can be manufactured in a continuous phase by adding additives in a spinning solution or molten solution or electrospinning the spinning solution or molten solution and collecting the electrospun spinning solution or molten solution in a wet process and containing the collected electrospun solution in a water bath, thereby completely separating the electrospun solution into individual fibers in the stretching step and the multiple heating and heat treatment steps. Therefore, the method for manufacturing uniformly separated nanofilaments or microfibers is capable of being usefully used in manufacturing fields of nanofibers such as varieties of filters, wound dressings, scaffolds, biomedical clothes, second battery separator membranes and nanocomposites, and in manufacturing fields of functional microfibers for improving conventional products.

Hereinafter, the present invention will be described in more detail with reference to the following examples and experimental examples. However, the following examples and experimental examples are provided for illustrative purposes only, and the scope of the present invention should not be limited thereto in any manner.

### Example 1

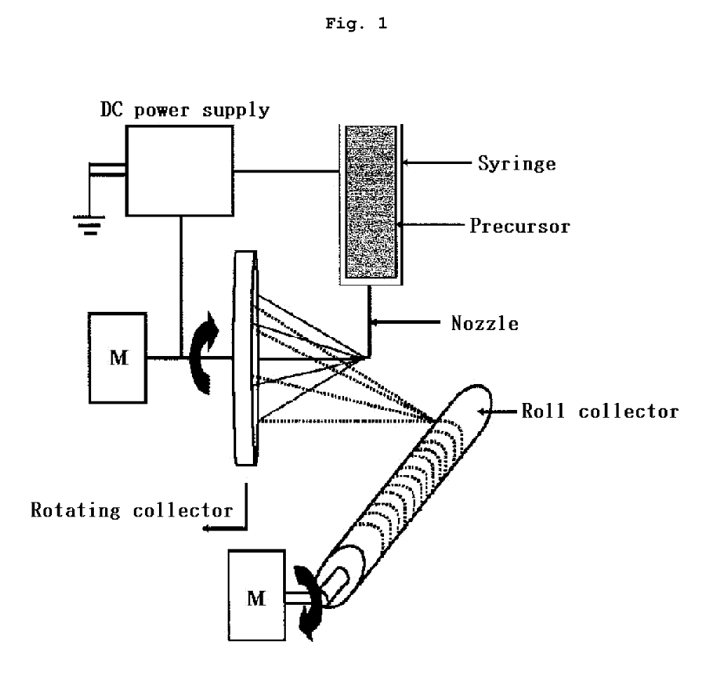

The mixture was sufficiently mixed by a stirrer in a state that 0.01 to 30% by weight of glycerol was added in the prepared spinning solution after preparing 25% by weight of a spinning solution by using polyamideimide as electrospinning raw material and by adding a polyamideimide resin in organic solvents of dimethylformaldehyde and N-methyl-2-pyrrolidone. An electrospinning apparatus used in the present invention included a quantitative solution feeder Model No. 100 manufactured by KD Scientific Inc., a high voltage generator KSHP-1001CD manufactured by KSH, and a spinning nozzle with an inner diameter of 0.16 mm and a length of 13 mm made of stainless steel and manufactured by Iwashita Industrial Co., Ltd. of Japan. The nanofibers were continuously collected by secondly collecting the primarily collected nanofibers on a winding roller after applying a voltage of 10 to 30 kV to an electrospinning apparatus illustrated in FIG. 1 and primarily collecting on a collector nanofibers manufactured as droplets of the spinning solution formed on the tip of the spinning nozzle were being broken. Uniformly separated nanofilaments were manufactured by heat-treating the stretched nanofibers at 320° C., at least glass transition temperature of the electrospinning raw material, for 10 to 180 minutes after stretching the manufactured nanofibers and holding the stretched nanofibers at 120° C., a boiling temperature or less of the organic solvent, for 10 to 180 minutes.

### Example 2

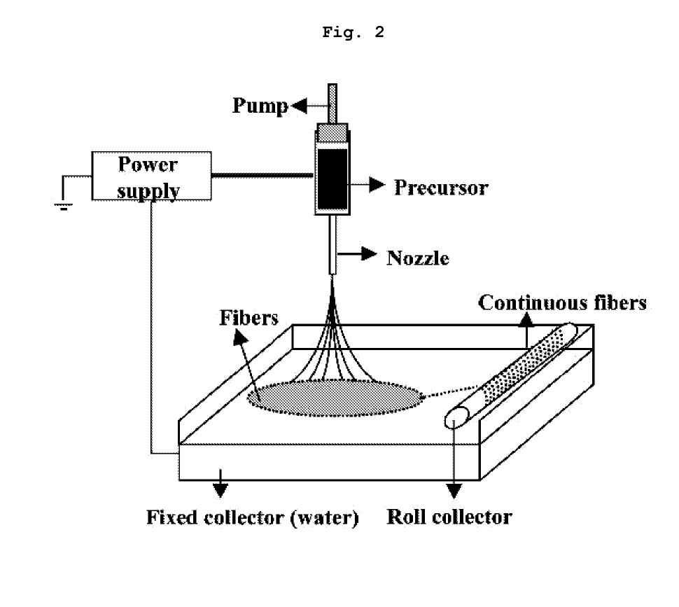

The spinning solution was sufficiently mixed by a stirrer after preparing 25% by weight of a spinning solution by using polyamideimide as electrospinning raw material and by adding a polyamideimide resin in organic solvents of dimethylformaldehyde and N-methyl-2-pyrrolidone. An electrospinning apparatus used in the present invention included a quantitative solution feeder Model No. 100 manufactured by KD Scientific Inc., a high voltage generator KSHP-1001CD manufactured by KSH, and a spinning nozzle with an inner diameter of 0.16 mm and a length of 13 mm made of stainless steel and manufactured by Iwashita Industrial Co., Ltd. of Japan. The primarily spun nanofibers were secondly collected on a winding roller after applying a voltage of 10 to 30 kV to an electrospinning apparatus illustrated in FIG. 2 and primarily spinning on a water bath containing 0.01 to 30% by weight of glycerol nanofibers manufactured as droplets of the spinning solution formed on the tip of the spinning nozzle were being broken. Uniformly separated nanofilaments were manufactured by heat-treating the stretched nanofibers at 310° C., at least glass transition temperature of the electrospinning raw material, for 30 to 120 minutes after stretching the manufactured nanofibers and holding the stretched nanofibers at 120° C., a boiling temperature or less of the organic solvent, and a reduced pressure condition of 0.1 to 100 mmHg for 30 to 360 minutes.

### Example 3

Uniformly separated microfibers were manufactured in the same method as that of the example 1 except that 12 to 35% by weight of moisture hardening polyurethane was used as electrospinning raw material, and a voltage of 1 to 10 kV was applied at a relative humidity of 100% during electrospinning.

### Example 4

Uniformly separated microfibers were manufactured in the same method as that of the example 1 except that 12 to 35% by weight of amine hardening polyurethane was used as electrospinning raw material, and a voltage of 1 to 10 kV was applied during electrospinning in a state that amine vapor was being supplied.

### Example 5

Uniformly separated nanofilaments were manufactured in the same method as that of the example 2 except that amic acid, a polyimide precursor, was used as electrospinning raw material.

### Example 6

Uniformly separated nanofilaments were manufactured in the same method as that of the example 2 except that polyvinyl alcohol was used as electrospinning raw material.

### Example 7

Uniformly separated nanofilaments were manufactured in the same method as that of the example 2 except that polyacrylonitrile was used as electrospinning raw material, and dimethylacetamide and dimethylsulfoxide were used as an organic solvent.

### Example 8

Uniformly separated nanofilaments were manufactured in the same method as that of the example 2 except that polycaprolactam was used as electrospinning raw material.

### Comparative Example 1

Nanofilaments were manufactured in the same method as that of the example 1 except that polyamideimide was used as electrospinning raw material, and glycerol was not used as an additive.

### Comparative Example 2

Nanofilaments were manufactured in the same method as that of the example 2 except that polyamideimide was used as electrospinning raw material, and glycerol was not used as an additive.

### Comparative Example 3

Nanofilaments were manufactured in the same method as that of the example 1 except that polyamideimide was used as electrospinning raw material, and stretching and multistep heat-increasing heat treatment processes were not performed.

### Comparative Example 4

Nanofilaments were manufactured in the same method as that of the example 2 except that polyamideimide was used as electrospinning raw material, and stretching and multistep heat-increasing heat treatment processes were not performed.

### Comparative Example 5

Nanofilaments were manufactured in the same method as that of the example 2 except that moisture hardening polyurethane was used as electrospinning raw material, glycerol was not used as an additive, and stretching and multistep heat-increasing heat treatment processes were not performed.

Manufacturing methods and fiber forms of the examples 1 to 8 and comparative examples 1 to 5 are represented in the following table 1.

[Table 1]

(⊚: when at least 90% of nanofilament bundles was separated into individual fibers, ∘: when at least 80% of nanofilament bundles was separated into individual fibers, and x: when not more than 80% of nanofilament bundles was separated into individual fibers)

Analysis

1. Viscosity Analysis of Polyamideimide Spinning Solution

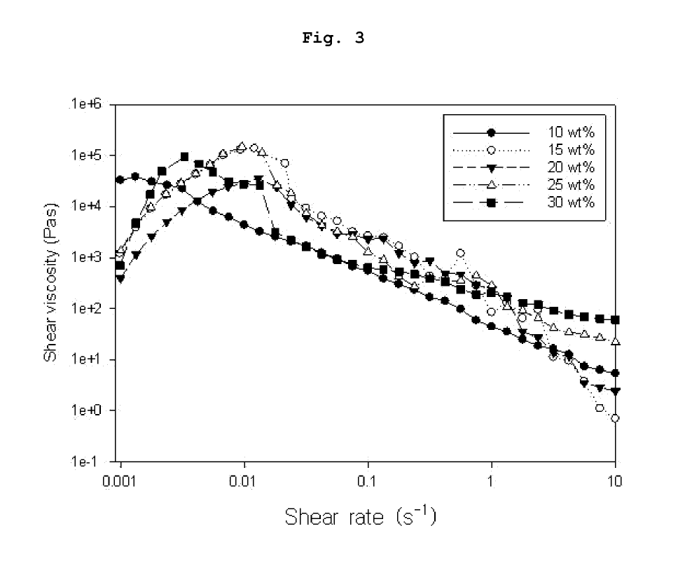

After analyzing the viscosity of a polyamideimide spinning solution as electrospinning raw material used in the present invention, analysis results were illustrated in FIG. 3.

When examining results of viscosity variations according to the concentration of the polyamideimide electrospinning raw material, it can be judged that the polymer chains are capable of being formed into nanofibers while entanglement is generated between polymer chains since the behavior of shear thinning in which the viscosity rapidly decreases as the shear rate increases is shown when the concentration of the polyamideimide electrospinning raw material is as low as 10% by weight, and since the behavior of yield stress is shown when the concentration of the polyamideimide electrospinning raw material is more than 15% by weight. Therefore, it can be seen that it is necessary to prepare at least 15% by weight of a polyamideimide solution in order to manufacture nanofibers successfully.

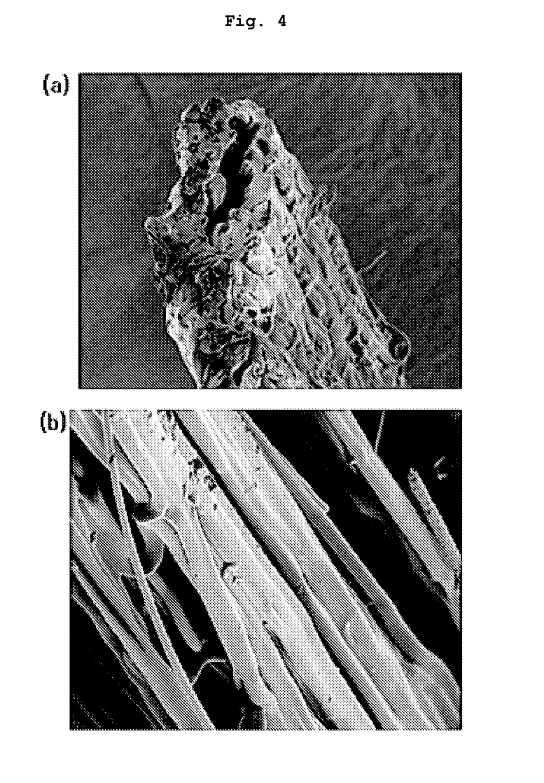

2. Analysis on Shapes of Nanofibers According to Stretching and Heat Treatment Processes without Using Additive
In order to find out the shapes of nanofibers according to stretching and heat treatment processes without using the additive, the shapes of the nanofibers were analyzed by a scanning electron microscope (SEM) TESCAN VEGA-II manufactured by Bruker Corporation, and analysis results were shown in FIG. 4. FIG. 4 (a) shows nanofibers manufactured without using the additive, and without the stretching and heat treatment processes being performed. FIG. 4 (b) shows nanofibers manufactured without using the additive, and with the stretching and heat treatment processes being performed.
As shown in FIG. 4, it can be seen that nanofibers of the comparative example 5 manufactured without using the additive, and without the stretching and heat treatment processes being performed are present in bundles, the nanofibers are tangled with one another, and the nanofibers of the comparative example 4 manufactured without using the additive, and with the stretching and heat treatment processes being performed are also tangled with one another.

### Experimental Example 1

### Analysis on Shapes of Nanofilaments According to Stretching and Heat Treatment Processes

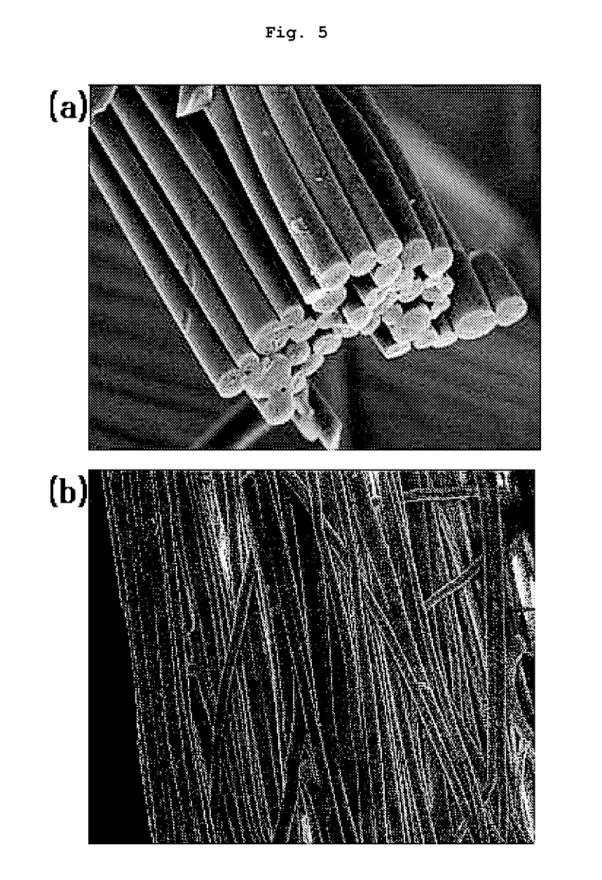

In order to find out shapes of nanofilaments manufactured by a manufacturing method according to the present invention and shapes of nanofibers manufactured without performing the stretching and heat treatment processes, the shapes of the nanofilaments and nanofibers were analyzed by a scanning electron microscope (SEM), and analysis results were shown in FIG. 5.
As shown in FIG. 5, it can be seen that the nanofilaments of the example 1 (FIG. 5 (a)) are uniformly separated into a uniform cylindrical shape, and the nanofibers of the comparative example 3 (FIG. 5 (b)) are present in bundles and are not uniformly separated.

### Experimental Example 2

### Analysis on Tensile Strength of Nanofilaments

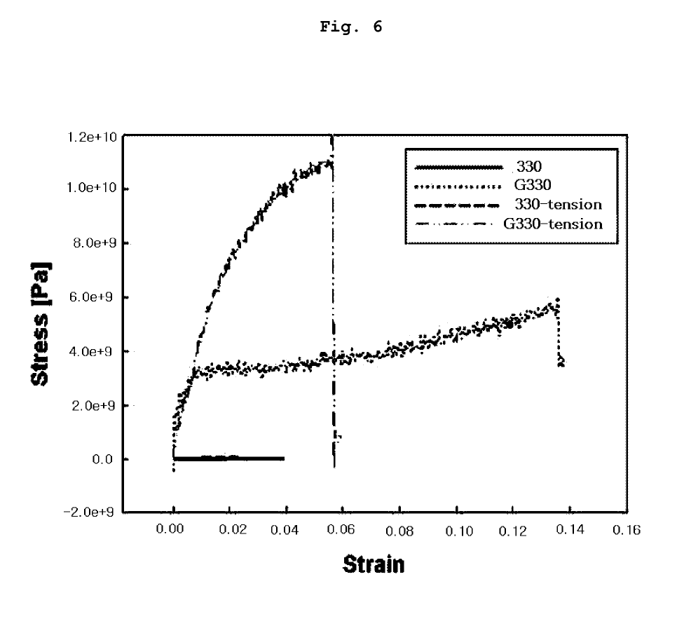

The following experiment was performed to analyze tensile strength of nanofilaments manufactured by a manufacturing method according to the present invention, and analysis results were shown in FIG. 6. As shown in FIG. 6, it can be seen that the nanofilaments of the example 1 manufactured by the manufacturing method according to the present invention shows a tensile strength value of 5 GPa or more, and nanofilaments of the comparative examples 1, 3 and 5 manufactured without the additive being added, and without the stretching and heat treatment processes being performed show low tensile strength values.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method for manufacturing uniformly separated nanofilaments, comprising: a first step of dissolving electrospinning raw material into an organic solvent to prepare a spinning solution or melting the electrospinning raw material to prepare a molten solution; a second step of primarily collecting the nanofibers in a dry or wet process and secondly collecting the primarily-collected nanofibers by a winding roller after electrospinning the spinning solution or molten solution prepared in the first step at a critical voltage of 10 to 30 kV to manufacture nanofibers; and a third step of heat-treating the stretched nanofibers at least glass transition temperature of the electrospinning raw material for a predetermined time after stretching the nanofibers manufactured in the second step and holding the stretched nanofibers at a boiling temperature of the organic solvent or less and an atmospheric pressure or reduced pressure condition for a predetermined time.

2. The method for manufacturing uniformly separated nanofilaments as set forth in claim 1, wherein the electrospinning raw material of the first step is polyimide, polyamideimide, polyurethane, polyacrylonitrile or polycaprolactam.

3. The method for manufacturing uniformly separated nanofilaments as set forth in claim 1, wherein the organic solvent of the first step is selected from the group consisting of dimethylformaldehyde, dimethylacetamide, dimethyl sulfoxide, N-methyl-2-pyrrolidone, or a combination of two or more thereof.

4. The method for manufacturing uniformly separated nanofilaments as set forth in claim 1, wherein the electrospinning raw material of the first step is contained in the spinning solution in the amount of 2 to 65% by weight with respect to the organic solvent.

5. The method for manufacturing uniformly separated nanofilaments as set forth in claim 1, wherein the spinning solution or molten solution of the first step further comprises 0.01 to 30% by weight of an additive.

6. The method for manufacturing uniformly separated nanofilaments as set forth in claim 5, wherein the additive is glycerol, polyethylene glycol, mineral oil, acetic acid, or citric acid.

7. The method for manufacturing uniformly separated nanofilaments as set forth in claim 1, further comprising a step of additionally heat-treating the spinning solution in a temperature range of 60 to 350° C. after performing the first step.

8. The method for manufacturing uniformly separated nanofilaments as set forth in claim 1, wherein the dry type collection process of the second step is carried out by a flat type collector, a roller type collector, or a multi-collector which is a mixed form of the flat type collector and roller type collector.

9. The method for manufacturing uniformly separated nanofilaments as set forth in claim 1, wherein the wet type collection process of the second step is carried out using a water bath containing glycerol, polyethylene glycol, mineral oil, acetic acid, or citric acid.

10. The method for manufacturing uniformly separated nanofilaments as set forth in claim 1, wherein the nanofibers manufactured in the second step are coated with an additive to a thickness of 10 to 30 μm.

11. The method for manufacturing uniformly separated nanofilaments as set forth in claim 1, the heat treatment process of the third step comprises heat-treating the stretched nanofibers at least glass transition temperature of the used electrospinning raw material for 10 to 360 minutes after holding the stretched nanofibers at a boiling temperature of the used solvent or less and an atmospheric pressure or reduced pressure condition for 5 to 360 minutes.

12. The method for manufacturing uniformly separated nanofilaments as set forth in claim 1, the heat treatment process of the third step comprises increasing temperature of the stretched nanofibers over multiple steps of 1 to 10 steps at a holding temperature of a boiling temperature or less of the organic solvent and in a temperature range of at least glass transition temperature of the electrospinning raw material.

13. A method for manufacturing microfibers, comprising using the manufacturing method of claim 1 to manufacture microfibers having a diameter range of 1 to 5 μm.

14. The method for manufacturing microfibers as set forth in claim 13, wherein the microfibers are manufactured by increasing the concentration of the spinning solution or molten solution used in manufacturing of the nanofilaments as much as 1.2 to 3.5 times according to the diameter of the microfibers, by maintaining a relative humidity of 100% during electrospinning, or by applying a voltage of 1 to 10 kV to amine vapor.

15. A method for manufacturing uniformly separated nanofilaments, comprising:
a) preparing a spinning solution or molten solution from an electrospinning raw material;
b) electrospinning the solution at a voltage of 10 to 30 kV to manufacture nanofibers;
c) primarily collecting the nanofibers in a dry or wet process;
d) collecting the primarily collected nanofibers with a winding roller;
e) stretching the nanofibers;
f) heating the stretched nanofibers to at least the glass transition temperature of the electrospinning raw material; and
g) holding the heated stretched nanofibers at a predetermined temperature and at or below atmospheric pressure for a predetermined time.
